(19) United States
(12) Patent Application Publication
(10) Pub. No.: US 2009/0065097 A1
(43) Pub. Date: Mar. 12, 2009

(54) LEAD-FREE SOLDER OF SN-0.7WT%CU

(76) Inventor: Minghan CHEN, Guangzhou (CN)

Correspondence Address: WANG & HO, 66 HILLTOP ROAD, MILLINGTON, NJ, 07946, US

(21) Appl. No.: 11/852,322

(22) Filed: Sep. 9, 2007

(51) Int. Cl. B23K 35/22

(52) U.S. Cl. 148/23

(57) ABSTRACT

An improved lead-free solder of Sn-0.7 wt % Cu which contains 0.001-1.5 wt % Ti and an alkaline element of Li, Na, K, Rb, Cs, etc. The alkaline element accounts for 0.0001-0.8 wt %. Compared with the traditional lead-free solder of Sn-0.7 wt % Cu, the lead-free solder of the present invention is characterized by the resulting welding spots with glossier and smoother surface, alloy solder with improved diffusivity, and solder surface with enhanced oxidation resistance.

### FIELD OF THE INVENTION

The present invention is related to a lead-free solder. Particularly, it is related to an improved Sn-0.7 wt % Cu lead-free solder.

### BACKGROUND OF THE INVENTION

The traditional solder of Sn-0.7 wt % Cu is eutectic Sn—Cu alloy with a melting point of 227° C., which is one of the conventional materials used as lead-free solders nowadays. However, there are many defects in the characteristics of the traditional solder of Sn-0.7 wt % Cu, such as coarse appearance and lack of luster on the surface of the welding spots, low weldability and diffusibility, and inclination to be oxidized when melted, which negatively affected the further application of the solder.

### SUMMARY OF THE INVENTION

The object of the present invention is to overcome the aforementioned disadvantages of traditional lead-free solder of Sn-0.7 wt % Cu and to provide an improved lead-free solder of Sn-0.7 wt % Cu which produces glossier and smoother surface of welding spots, higher diffusivity of the alloy solder, and enhanced oxidation resistance of the solder surface.

The object of the present invention is realized through the following technical solutions.

An improved lead-free solder of Sn-0.7 wt % Cu, which is characterized by addition of Ti to the traditional lead-free solder of Sn-0.7 wt % Cu.

According to the present invention, Ti added in the lead-free solder accounts for 0.001-1.5 wt %, and preferably, it accounts for 0.01-1.3 wt %.

As a further improvement of the present invention, a small amount of alkaline elements, in addition to Ti, is added to the traditional lead-free solder of Sn-0.7 wt % Cu.

The alkaline element used in the present invention is Li, Na, K, Rb or Cs, etc.

The alkaline elements in the lead-free solder, according to the present invention, accounts for 0.0001-0.8 wt %. Preferably, it accounts for 0.001-0.5 wt %.

Compared with traditional lead-free solder of Sn-0.7 wt % Cu, the present invention has the following technical effects:
1. Addition of a proper amount of Ti results in glossy and smooth crystallization effects on the surface of welding spots.
2. Addition of proper amount of Ti improves the diffusibility of the solder alloy by 5%. The improvement can be further enhanced to 8-10% with addition of a small amount of alkaline element.
3. Addition of proper amount of Ti enhances oxidation resistance on the surface of the solder at 240-270° C., while the surface of the traditional solder of Sn-0.7 wt % Cu without Ti or Ti+ alkaline elements, after being melted, will be quickly covered by a large amount of oxidation film, which turns from bright-yellow to dark-brown.

### DETAILED DESCRIPTION OF THE INVENTION

### Specific Embodiments

According to the present invention, the key point in making the improved lead-free solder is to strictly control the content of Ti and an alkaline element selected from the group consisting of Li, Na, K, Rb and Cs. The process starts with preparations of two homogeneous intermediate alloys: intermediate alloy of Cu—Ti and intermediate alloy of Sn-alkaline elements. Then chemical analysis is carried out on the two homogeneous intermediate alloys to determine the precise contents of Ti and alkaline element. Each is taken in an accurate amount to afford the final alloy according to the actual content requirements for the ingredients. After the process of making the alloy solder is complete, analysis is performed to determine the actual content of Cu, Ti and alkaline elements in the resulting solder. Lastly, various tests are conducted to determine the resulting alloy solder's performance.

### EXAMPLE 1

This example provides an improved lead-free solder of Sn-0.7 wt % Cu, the composition of which is Sn-0.7 wt % Cu-0.05 wt % Ti.

### EXAMPLE 2

This example provides an improved lead-free solder of Sn-0.7 wt % Cu, the composition of which is Sn-0.7 wt % Cu-1.0 wt % Ti.

### EXAMPLE 3

This example provides an improved lead-free solder of Sn-0.7 wt % Cu, the composition of which is Sn-0.7 wt % Cu-1.5 wt % Ti.

### EXAMPLE 4

This example provides an improved lead-free solder of Sn-0.7 wt % Cu, the composition of which is Sn-0.7 wt % Cu-0.005 wt % Ti-0.005 wt % K.

### EXAMPLE 5

This example provides an improved lead-free solder of Sn-0.7 wt % Cu, the composition of which is Sn-0.7 wt % Cu-0.01 wt % Ti-0.001 wt % Na.

### EXAMPLE 6

This example provides an improved lead-free solder of Sn-0.7 wt % Cu, the composition of which is Sn-0.7 wt % Cu-0.05 wt % Ti-0.05 wt % K.

### EXAMPLE 7

This example provides an improved lead-free solder of Sn-0.7 wt % Cu, the composition of which is Sn-0.7 wt % Cu-0.8 wt % Ti-0.2 wt % Rb.

### EXAMPLE 8

This example provides an improved lead-free solder of Sn-0.7 wt % Cu, the composition of which is Sn-0.7 wt % Cu-1.0 wt % Ti-0.5 wt % Cs.

### EXAMPLE 9

This example provides an improved lead-free solder of Sn-0.7 wt % Cu, the composition of which is Sn-0.7 wt % Cu-1.3 wt % Ti-0.8 wt % Li.

### EXAMPLE 10

This example provides an improved lead-free solder of Sn-0.7 wt % Cu, the composition of which is Sn-0.7 wt % Cu-1.5 wt % Ti-0.5 wt % Na.

Comparison between conventional Sn-0.7 wt % Cu solder and various improved versions made in the preceding examples of the present invention on their welding performance and corrosion resistance are presented in Table 1 and Table 2, respectively.

TABLE 1
Performance Comparison between Conventional Sn—0.7 wt % Cu solder and Improved Versions of Present Invention

| | Composition (wt) % | | | | Melting | | Tensile | | | Wettability | |
|---|---|---|---|---|---|---|---|---|---|---|---|
| | | | | Alkaline | point | Density | stress | Elongation | | To-x | Resistivity |
| | Sn | Cu | Ti | elements | ° C. | g/cm³ | MPa | rate % | diffusivity % | Fmax | μΩm |
| Example 1 | 99.25 | 0.7 | 0.05 | / | ~227 | ~7.4 | 35 | 24 | 76 | 0.3-0.4″ | 0.12850 |
| | | | | | | | | | | 60 Dyn | |
| Example 2 | 98.30 | 0.7 | 1.0 | / | ~227 | ~7.4 | 38 | 23 | 74 | 0.3-0.4″ | 0.12848 |
| | | | | | | | | | | 60 Dyn | |
| Example 3 | 97.80 | 0.7 | 1.5 | / | ~227 | ~7.4 | 42 | 18 | 70 | 0.3-0.4″ | 0.12849 |
| | | | | | | | | | | 60 Dyn | |
| Example 4 | 99.29 | 0.7 | 0.005 | 0.005 | ~227 | ~7.4 | 35 | 24 | 80 | 0.3″ | 0.12830 |
| | | | | | | | | | | 65 Dyn | |
| Example 5 | 99.289 | 0.7 | 0.01 | 0.001 | ~227 | ~7.4 | 35 | 24 | 82 | 0.3″ | 0.12829 |
| | | | | | | | | | | 65 Dyn | |
| Example 6 | 99.20 | 0.7 | 0.05 | 0.05 | ~227 | ~7.4 | 35 | 24 | 84 | 0.2″ | 0.12828 |
| | | | | | | | | | | 65 Dyn | |
| Example 7 | 98.30 | 0.7 | 0.8 | 0.2 | ~227 | ~7.4 | 37 | 22 | 78 | 0.3″ | 0.12831 |
| | | | | | | | | | | 65 Dyn | |
| Example 8 | 97.80 | 0.7 | 1.0 | 0.5 | ~227 | ~7.4 | 38 | 22 | 76 | 0.3-0.4″ | 0.12832 |
| | | | | | | | | | | 60 Dyn | |
| Example 9 | 97.20 | 0.7 | 1.3 | 0.8 | ~227 | ~7.4 | 40 | 22 | 75 | 0.3-0.4″ | 0.12827 |
| | | | | | | | | | | 60 Dyn | |
| Example 10 | 97.00 | 0.7 | 1.5 | 0.8 | ~227 | ~7.4 | 42 | 16 | 75 | 0.3-0.4″ | 0.12832 |
| | | | | | | | | | | 60 Dyn | |
| Conventional | 99.30 | 0.7 | / | / | ~227 | ~7.4 | 35 | 27 | 72 | 0.5″ | 0.12601 |
| Sn—0.7 wt % Cu | | | | | | | | | | 55 Dyn | |

TABLE 2
Corrosion Resistance Comparison between Conventional Sn—0.7 wt % Cu solder and Improved
Versions of Present Invention

| | Composition (wt) % | | | | Weight increment | |
|---|---|---|---|---|---|---|
| | | | | Alkaline | by corrosion | |
| | Sn | Cu | Ti | element | mg/mm² | Surface condition |
| Example 1 | 99.25 | 0.7 | 0.05 | / | 0.00054 | Glossy, smooth crystallization |
| Example 2 | 98.30 | 0.7 | 1.0 | / | 0.00055 | Glossy, smooth crystallization |
| Example 3 | 97.80 | 0.7 | 1.5 | / | 0.00053 | Glossy, smooth crystallization |
| Example 4 | 99.29 | 0.7 | 0.005 | 0.005 | 0.00050 | Glossy, smooth crystallization |
| Example 5 | 99.289 | 0.7 | 0.01 | 0.001 | 0.00048 | Glossy, smooth crystallization |
| Example 6 | 99.20 | 0.7 | 0.05 | 0.05 | 0.00050 | Glossy, smooth crystallization |
| Example 7 | 98.30 | 0.7 | 0.8 | 0.2 | 0.00049 | Glossy, smooth crystallization |
| Example 8 | 97.80 | 0.7 | 1.0 | 0.5 | 0.00050 | Glossy, smooth crystallization |
| Example 9 | 97.20 | 0.7 | 1.3 | 0.8 | 0.00047 | Glossy, smooth crystallization |
| Example 10 | 97.00 | 0.7 | 1.5 | 0.8 | 0.00049 | Glossy, smooth crystallization |
| Conventional | 99.30 | 0.7 | / | / | 0.00066 | Dark gray, lack of luster coarse |
| Sn—0.7 wt % Cu | | | | | | crystallization |

Note:
The corrosive medium is NaCl 5 wt % + H₂O, 200 h, 35° C.

The foregoing results demonstrated that, compared with the traditional alloy solder of Sn-0.7 wt % Cu, the performance of the improved lead-free solder of the present invention is greatly enhanced.

The improved lead-free solder according to the present invention, when matched with high quality flux, is applicable to hot air leveling of PCB and flow welding of THT.

While a number of preferred embodiments of the present invention are presented in the above, it will be understood that various changes and alterations can be made by technicians of ordinary skill in the related field without departing from the spirit of the invention and therefore, they are all covered and protected.

What is claimed is:

1. A lead-free solder, comprising Sn, Cu, and Ti.

2. The lead-free solder of claim 1, further comprising an alkaline element.

3. The lead-free solder of claim 1, wherein said Ti accounts for 0.001-1.5% by weight.

4. The lead-free solder of claim 2, wherein said Ti accounts for 0.001-1.5% by weight.

5. The lead-free solder of claim 3, wherein said Ti accounts for 0.01-1.3% by weight.

6. The lead-free solder of claim 4, wherein said Ti accounts for 0.01-1.3% by weight, said alkaline element being Li, Na, K, Rb or Cs.

7. The lead-free solder of claim 2, wherein said alkaline element is Li, Na, K, Rb or Cs.

8. The lead-free solder of claim 7, wherein said alkaline element accounts for 0.0001-0.8% by weight.

9. The lead-free solder of claim 8, wherein said alkaline element accounts for 0.001-0.5% by weight.

10. The lead-free solder of claim 1, consisting of Sn, Cu, and Ti.

11. The lead-free solder of claim 10, consisting of Sn, Cu, Ti, and alkaline element.

12. The lead-free solder of claim 11, wherein said alkaline element is selected from the group consisting of Li, Na, K, Rb and Cs.

13. An method of enhancing welding performance of lead-free solder of SN-0.7 WT % CU, comprising a step of adding Ti in said lead-free solder.

14. The method of claim 13, wherein said Ti accounts for 0.001-1.5% by weight.

15. The method of claim 14, wherein said Ti accounts for 0.01-1.3% by weight.

16. The method of claim 13, further comprising a second step of adding an alkaline element in said lead-free solder.

17. The method of claim 16, wherein said alkaline element is selected from the group consisting of Li, Na, K, Rb and Cs.

18. The method of claim 17, wherein said alkaline element accounts for 0.0001-0.8% by weight.

19. The lead-free solder of claim 18, wherein said alkaline element accounts for 0.001-0.5% by weight.
